(19) United States
(12) Patent Application Publication
(10) Pub. No.: US 2024/0092444 A1
(43) Pub. Date: Mar. 21, 2024

(54) Motorcycle Footwear Covering Device

(71) Applicant: Grace McBride, Chicago, IL (US)

(72) Inventor: Grace McBride, Chicago, IL (US)

(21) Appl. No.: 18/302,583

(22) Filed: Apr. 18, 2023

Related U.S. Application Data
(60) Provisional application No. 63/408,606, filed on Sep. 21, 2022.

(51) Int. Cl. B62J 23/00

(52) U.S. Cl. CPC B62J 23/00

(57) ABSTRACT

The present invention relates to a motorcycle footwear covering device for eliminating vibration transferred from a motorcycle to a motorcycle rider. The device is primarily comprised of a body with a top wall and a bottom wall that forms an opening. The device can be placed around a piece of footwear via the elastic material of the top wall and the opening. The foot peg of the motorcycle may also be received by a recessed area on the bottom wall. The body may also be comprised of any type of decorative indicia. During use, the rubber material of the device absorbs vibration from the foot peg.

### CROSS-REFERENCE TO RELATED APPLICATION

The present application claims priority to, and the benefit of, U.S. Provisional Application No. 63/408,606, which was filed on Sep. 21, 2022, and is incorporated herein by reference in its entirety.

### FIELD OF THE INVENTION

The present invention relates generally to the field of footwear covers. More specifically, the present invention relates to a motorcycle footwear covering device primarily comprised of a body with a top wall and a bottom wall that forms an opening. The device can be placed around a piece of footwear via the elastic material of the top wall and the opening. The foot peg of the motorcycle may also be received by a recessed area on the bottom wall. The body may also be comprised of any type of decorative indicia. During use, the rubber material of the device absorbs vibration from the foot peg. Accordingly, the present disclosure makes specific reference thereto. Nonetheless, it is to be appreciated that aspects of the present invention are also equally applicable to other like applications, devices, and methods of manufacture.

### BACKGROUND

When riding a motorcycle, a rider places their feet on a pair of horizontal foot pegs near the base of the cycle. While riding, vibrations from the engine may resonate through the foot peg, into the feet of the rider, and travel up the rider's body. This may be an uncomfortable and unpleasant sensation for some riders, which is undesirable.

Therefore, there exists a long-felt need in the art for a device that can be used to eliminate vibrations experienced by a motorcycle rider. More specifically, there exists a long-felt need in the art for a motorcycle footwear covering device that eliminates vibrations experienced by a motorcycle rider that is transferred by the foot pegs of a motorcycle. There also exists a long-felt need in the art for a motorcycle footwear covering device that eliminates vibrations experienced by a motorcycle rider that is transferred by the foot pegs of a motorcycle, wherein the device can be universally used. Further, there exists a long-felt need in the art for a motorcycle footwear covering device that eliminates vibrations experienced by a motorcycle rider that is transferred by the foot pegs of a motorcycle, wherein the device is visually appealing.

The subject matter disclosed and claimed herein, in one embodiment thereof, comprises a motorcycle footwear covering device. The device is primarily comprised of a body with a top wall and a bottom wall that forms an opening. The device can be placed around a piece of footwear via the elastic material of the top wall and the opening. The bottom wall is preferably comprised of a texture to aid in the device gripping a foot peg of a motorcycle. The foot peg of the motorcycle may also be received by a recessed area on the bottom wall. The body may also be comprised of any type of decorative indicia. During use, the rubber material of the device absorbs vibration from the foot peg.

In this manner, the motorcycle footwear covering device of the present invention accomplishes all the foregoing objectives and provides a motorcycle footwear covering device that eliminates vibrations experienced by a motorcycle rider that is transferred by the foot pegs of a motorcycle. The device can be universally used on any type of footwear. In addition, the device is visually appealing.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motorcycle footwear covering device primarily comprised of a body with a top wall, a bottom wall, and an opening. The top wall is preferably inseparably attached to the bottom wall. The top wall is convex in shape such that a user can insert the device around the mid-foot area of their footwear via the opening of the body.

The top wall is preferably made from an elastic, flexible rubber material. This allows the device to be secured to footwear via compressive force. The bottom wall is preferably also made from a rubber material. However, the bottom wall may be flexible or rigid. A rigid embodiment allows a user to easily walk while wearing the device on a piece of footwear. The rigid embodiment also provides more structural stability to the body.

Both rubber material used for the top wall and bottom wall preferably possess vibration-dampening properties such that when a user places their footwear on a motorcycle peg while wearing the device around the footwear, any vibration from the motorcycle is dampened/absorbed by the device. As a result, the vibration is not transferred to the footwear and body of the user.

The bottom surface of the bottom wall may be comprised of at least one texture that may be a raised and/or recessed texture that creates a non-slip effect that improves the grip of the bottom surface. In this manner, the bottom surface does not slip off of a motorcycle peg or cause the user to slip while walking. The texture may be arranged in any tread pattern, style, shape, orientation, or arrangement known in the art. The bottom surface of the top wall and the top surface of the bottom wall may also be comprised of the same texture to ensure the device does slip off from around the footwear during use.

Accordingly, the motorcycle footwear covering device of the present invention is particularly advantageous as it provides a motorcycle footwear covering device that eliminates vibrations experienced by a motorcycle rider that is transferred by the foot pegs of a motorcycle. The device can be universally used on any type of footwear. In addition, the device is visually appealing. In this manner, the motorcycle footwear covering device provides a novel solution to vibration reduction while riding a motorcycle.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a motorcycle footwear covering device of the present invention while placed over footwear in accordance with the disclosed architecture;

FIG. 2 illustrates a top perspective view of one potential embodiment of a motorcycle footwear covering device of the present invention in accordance with the disclosed architecture;

FIG. 3 illustrates a bottom perspective view of one potential embodiment of a motorcycle footwear covering device of the present invention in accordance with the disclosed architecture; and

FIG. 4 illustrates a perspective view of one potential embodiment of a motorcycle footwear covering device of the present invention while placed over footwear in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to eliminate vibrations experienced by a motorcycle rider. More specifically, there exists a long-felt need in the art for a motorcycle footwear covering device that eliminates vibrations experienced by a motorcycle rider that is transferred by the foot pegs of a motorcycle. There also exists a long-felt need in the art for a motorcycle footwear covering device that eliminates vibrations experienced by a motorcycle rider that is transferred by the foot pegs of a motorcycle, wherein the device can be universally used. Further, there exists a long-felt need in the art for a motorcycle footwear covering device that eliminates vibrations experienced by a motorcycle rider that is transferred by the foot pegs of a motorcycle, wherein the device is visually appealing.

The present invention, in one exemplary embodiment, is comprised of a motorcycle footwear covering device primarily comprised of a body with a top wall, a bottom wall, and an opening. The top wall is preferably inseparably attached to the bottom wall, wherein the top wall is convex in shape such that a user can insert the device around the mid-foot area of their footwear via the opening of the body. The top wall is preferably made from an elastic, flexible rubber material. This allows the device to be secured to footwear via compressive force.

The bottom wall is preferably also made from a rubber material. However, the bottom wall may be flexible or rigid. A rigid embodiment allows a user to easily walk while wearing the device on a piece of footwear. The rigid embodiment also provides more structural stability to the body.

Both rubber material used for the top wall and bottom wall preferably possess vibration-dampening properties. As a result, when a user places their footwear on a motorcycle peg while wearing the device around the footwear, any vibration from the motorcycle is dampened/absorbed by the device. As a result, the vibration is not transferred to the footwear and body of the user.

The bottom surface of the bottom wall may be comprised of at least one texture that may be a raised and/or recessed texture that creates a non-slip effect that improves the grip of the bottom surface. In this manner, the bottom surface does not slip off of a motorcycle peg or cause the user to slip while walking. The texture may be arranged in any tread pattern, style, shape, orientation, or arrangement known in the art. The bottom surface of the top wall and the top surface of the bottom wall may also be comprised of the same texture to ensure the device does slip off from around the footwear during use.

Accordingly, the motorcycle footwear covering device of the present invention is particularly advantageous as it provides a motorcycle footwear covering device that eliminates vibrations experienced by a motorcycle rider that is transferred by the foot pegs of a motorcycle. The device can be universally used on any type of footwear. In addition, the device is visually appealing. In this manner, the motorcycle footwear covering device provides a novel solution to vibration reduction while riding a motorcycle.

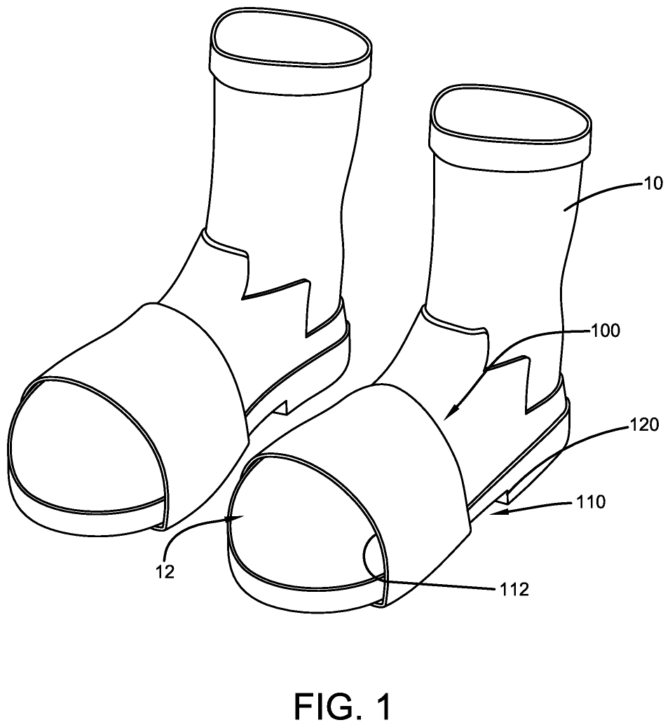

Referring initially to the drawings, FIG. 1 illustrates a perspective view of one potential embodiment of a motorcycle footwear covering device 100 of the present invention while placed over footwear 10 in accordance with the disclosed architecture. The device 100 is primarily comprised of a body 110 with a top wall 120, a bottom wall 130, and an opening 112. The top wall 120 is preferably inseparably attached to the bottom wall 130. The top wall 120 is convex in shape such that a user can insert the device 100 around the mid-foot area 12 of their footwear 10 via the opening of the body 110. The device 100 may be a plurality of sizes and shapes in order to fit any footwear 10 size, shape, and type known in the art.

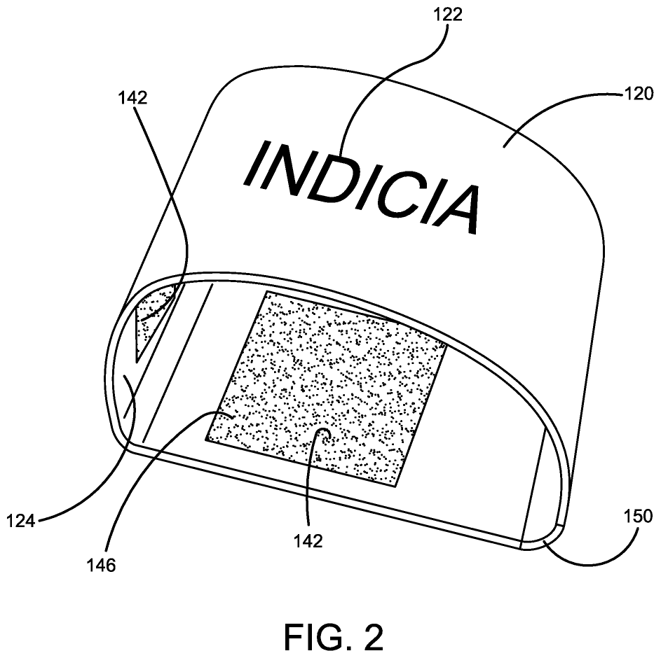

Any portion of the body 110, but preferably the top wall 120, may be comprised of at least one indicia 122, as seen in FIG. 2. The indicia 122 may include, but is not limited to, patterns, logos, emblems, images, symbols, designs, letters, numbers, words, characters, animals, advertisements, brands, etc. The indicia 122 may be recessed or raised from the body 110. The body 110 may be any color known in the art.

The top wall 120 is preferably made from an elastic, flexible rubber material such as, but not limited to, Neoprene, silicone, nitrile, EPDM, Styrene-Butadiene, Butyl, natural, fluorosilicone, natural rubbers, neoprene rubber elastomer, silicone rubber elastomer, ethylene propylene diene monomer rubber, butyl rubber, nitrile rubber, buna-n rubber, styrene-butadiene rubber elastomers, viton rubber elastomer, diaphragm rubber, thermoplastic rubber, etc. This allows the device 100 to be secured to footwear 10 via compressive force.

The bottom wall 130 is preferably also made from a rubber material. However, the bottom wall 130 may be flexible or rigid. A rigid embodiment allows a user to easily walk while wearing the device 100 on a piece of footwear 10. The rigid embodiment also provides more structural stability to the body 110.

The rubber material used for the top wall 120 and bottom 130 wall preferably possess vibration-dampening properties. In this manner, when a user places their footwear 10 on a motorcycle peg while wearing the device 100 around the footwear 10, any vibration from the motorcycle is dampened/absorbed by the device 100. As a result, the vibration is not transferred to the footwear 10 and body of the user.

In one embodiment, the body 110 may be reinforced via at least one reinforced material 150. The material 150 is preferably located within the body 110. More specifically, the material 150 is preferably located at the area inside the body 110 where the top wall 120 meets the bottom wall 130 to provide additional structural support in this area to prevent tearing. The material 150 may be comprised of any metal, rubber, or plastic material known in the art that may be flexible, semi-rigid, or rigid.

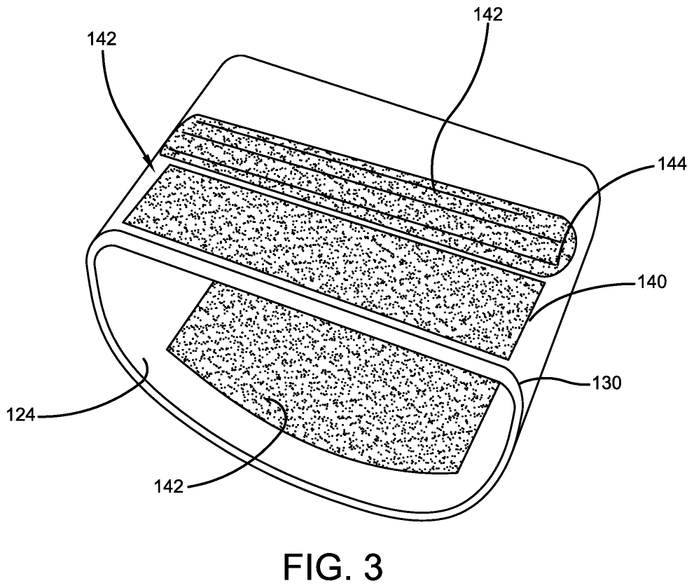

The bottom surface 140 of the bottom wall 130 may be comprised of at least one texture 142, as seen in FIG. 3. In differing embodiments, the texture 142 may be a raised and/or recessed texture that creates a non-slip effect that improves the grip of the bottom surface 140. In this manner, the bottom surface 140 does not slip off of a motorcycle peg or cause the user to slip while walking. The texture 142 may be arranged in any tread pattern, style, shape, orientation, or arrangement known in the art.

Similarly, the bottom surface 124 of the top wall 120 and the top surface 146 of the bottom wall 130 may be comprised of the same texture 142. This ensures the device 100 does slip off from around the footwear 10 during use.

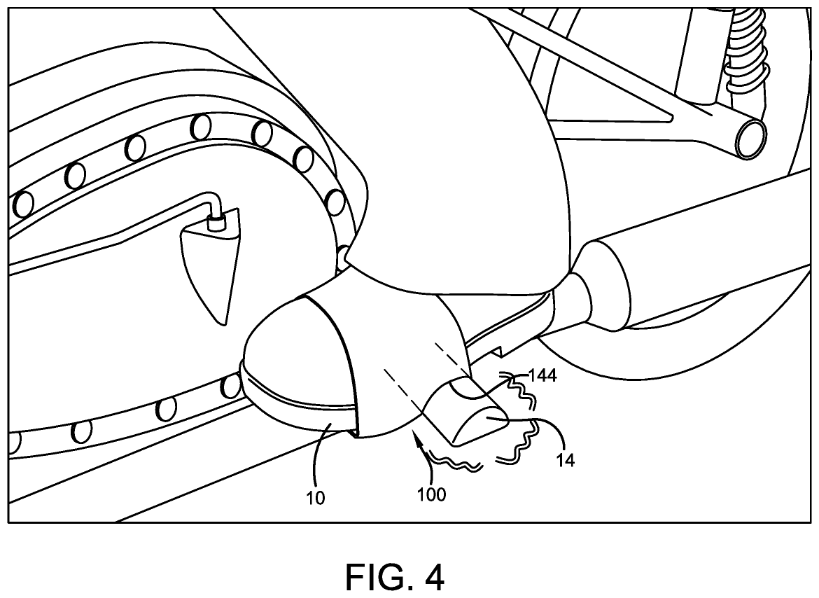

The bottom surface 140 of the bottom wall 130 may also be comprised of at least one recessed area 144. The recessed area 144 is shaped to receive the foot peg 14 of a motorcycle, as seen in FIG. 4. In this manner, the device 100 provides a better grip on the foot peg 14. The recessed area 144 may also be comprised of the texture 142 described above.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “motorcycle footwear covering device” and “device” are interchangeable and refer to the motorcycle footwear covering device 100 of the present invention.

Notwithstanding the foregoing, the motorcycle footwear covering device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the motorcycle footwear covering device 100 as shown in the FIGS. are for illustrative purposes only, and that many other sizes and shapes of the motorcycle footwear covering device 100 are well within the scope of the present disclosure. Although the dimensions of the motorcycle footwear covering device 100 are important design parameters for user convenience, the motorcycle footwear covering device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A motorcycle footwear covering device comprising:
an indicia;
a top wall;
a bottom wall comprised of a texture; and
an opening.

2. The motorcycle footwear covering device of claim 1, wherein the top wall and the bottom wall are comprised of a vibration-dampening rubber material.

3. The motorcycle footwear covering device of claim 1, wherein the top wall attaches to the bottom wall.

4. The motorcycle footwear covering device of claim 1, wherein the indicia is comprised of a recessed indicia.

5. A motorcycle footwear covering device comprising:
a top wall comprised of a first texture;
a bottom wall comprised of a second texture; and
an opening.

6. The motorcycle footwear covering device of claim 5 wherein the first texture is comprised of a raised texture.

7. The motorcycle footwear covering device of claim 6, wherein the first texture is comprised of a recessed texture.

8. The motorcycle footwear covering device of claim 6, wherein the first texture is positioned on a bottom surface of the top wall.

9. The motorcycle footwear covering device of claim 6, wherein the second texture is comprised of a raised texture.

10. The motorcycle footwear covering device of claim 6, wherein the second texture is comprised of a recessed texture.

11. The motorcycle footwear covering device of claim 6, wherein the second texture is positioned on a top surface of the bottom wall.

12. The motorcycle footwear covering device of claim 6, wherein the second texture is positioned on a bottom surface of the bottom wall.

13. A motorcycle footwear covering device comprising:
a top wall comprised of a first texture;
a bottom wall comprised of a second texture;
an opening; and
a reinforced material.

14. The motorcycle footwear covering device of claim 13, wherein the reinforced material is comprised of a plastic, a rubber, or a metal material.

15. The motorcycle footwear covering device of claim 14, wherein the reinforced material is positioned within the top wall.

16. The motorcycle footwear covering device of claim 15, wherein the reinforced material is positioned within the bottom wall.

17. The motorcycle footwear covering device of claim 14, wherein the top wall is comprised of a flexible rubber material.

18. The motorcycle footwear covering device of claim 14, wherein the bottom wall is comprised of a rigid rubber material.

19. The motorcycle footwear covering device of claim 14, wherein a bottom surface of the bottom wall is comprised of a recessed area.

20. The motorcycle footwear covering device of claim 14, wherein the recessed area is comprised of a texture.
